(19) United States
(12) Patent Application Publication
(10) Pub. No.: US 2026/0222994 A1
(43) Pub. Date: Jul. 30, 2026

(54) DYNAMIC USER EQUIPMENT GROUPING FOR LOW POWER WAKEUP SIGNAL MONITORING

(71) Applicant: QUALCOMM Incorporated, San Diego, CA (US)

(72) Inventors: Chao WEI, Beijing (CN); Wanshi CHEN, San Diego, CA (US); Yuchul KIM, San Diego, CA (US); Ahmed ELSHAFIE, San Diego, CA (US); Wei YANG, San Diego, CA (US); Peter GAAL, San Diego, CA (US)

(21) Appl. No.: 19/143,229

(22) PCT Filed: Feb. 14, 2023
(86) PCT No.: PCT/CN2023/075855

§ 371 Date: Jun. 25, 2025

(51) Int. Cl. H04W 52/02

(52) U.S. Cl. CPC H04W 52/0235

(57) ABSTRACT

Various aspects of the present disclosure generally relate to wireless communication. In some aspects, a user equipment (UE) may receive, from a network node, information configuring a hopping pattern for monitoring a low-power wakeup signal (LP-WUS) based at least in part on one or more characteristics associated with the UE. The UE may monitor, using a low-power wakeup receiver (LP-WUR), a wakeup signal (WUS) resource for the LP-WUS based at least in part on the hopping pattern. The UE may wake a main radio from a deep sleep state based at least in part on the LP-WUR detecting the LP-WUS. Numerous other aspects are described.

### FIELD OF THE DISCLOSURE

Aspects of the present disclosure generally relate to wireless communication and to techniques and apparatuses associated with dynamic user equipment (UE) grouping for low power wakeup signal (LP-WUS) monitoring.

### BACKGROUND

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power, or the like). Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, time division synchronous code division multiple access (TD-SCDMA) systems, and Long Term Evolution (LTE). LTE/LTE-Advanced is a set of enhancements to the Universal Mobile Telecommunications System (UMTS) mobile standard promulgated by the Third Generation Partnership Project (3GPP).

A wireless network may include one or more network nodes that support communication for wireless communication devices, such as a user equipment (UE) or multiple UEs. A UE may communicate with a network node via downlink communications and uplink communications. “Downlink” (or “DL”) refers to a communication link from the network node to the UE, and “uplink” (or “UL”) refers to a communication link from the UE to the network node. Some wireless networks may support device-to-device communication, such as via a local link (e.g., a sidelink (SL), a wireless local area network (WLAN) link, and/or a wireless personal area network (WPAN) link, among other examples).

The above multiple access technologies have been adopted in various telecommunication standards to provide a common protocol that enables different UEs to communicate on a municipal, national, regional, and/or global level. New Radio (NR), which may be referred to as 5G, is a set of enhancements to the LTE mobile standard promulgated by the 3GPP. NR is designed to better support mobile broadband internet access by improving spectral efficiency, lowering costs, improving services, making use of new spectrum, and better integrating with other open standards using orthogonal frequency division multiplexing (OFDM) with a cyclic prefix (CP) (CP-OFDM) on the downlink, using CP-OFDM and/or single-carrier frequency division multiplexing (SC-FDM) (also known as discrete Fourier transform spread OFDM (DFT-s-OFDM)) on the uplink, as well as supporting beamforming, multiple-input multiple-output (MIMO) antenna technology, and carrier aggregation. As the demand for mobile broadband access continues to increase, further improvements in LTE, NR, and other radio access technologies remain useful.

### SUMMARY

Some aspects described herein relate to a method of wireless communication performed by a user equipment (UE). The method may include receiving, from a network node, information configuring a hopping pattern for monitoring a low-power wakeup signal (LP-WUS) based at least in part on one or more characteristics associated with the UE. The method may include monitoring, using a low-power wakeup receiver (LP-WUR), a wakeup signal (WUS) for the LP-WUS based at least in part on the hopping pattern. The method may include waking a main radio from a deep sleep state based at least in part on the LP-WUR detecting the LP-WUS.

Some aspects described herein relate to a UE for wireless communication. The UE may include a memory and one or more processors coupled to the memory. The one or more processors may be configured to receive, from a network node, information configuring a hopping pattern for monitoring an LP-WUS based at least in part on one or more characteristics associated with the UE. The one or more processors may be configured to monitor, using an LP-WUR, a WUS for the LP-WUS based at least in part on the hopping pattern. The one or more processors may be configured to wake a main radio from a deep sleep state based at least in part on the LP-WUR detecting the LP-WUS.

Some aspects described herein relate to a non-transitory computer-readable medium that stores a set of instructions for wireless communication by a UE. The set of instructions, when executed by one or more processors of the UE, may cause the UE to receive, from a network node, information configuring a hopping pattern for monitoring an LP-WUS based at least in part on one or more characteristics associated with the UE. The set of instructions, when executed by one or more processors of the UE, may cause the UE to monitor, using an LP-WUR, a WUS for the LP-WUS based at least in part on the hopping pattern. The set of instructions, when executed by one or more processors of the UE, may cause the UE to wake a main radio from a deep sleep state based at least in part on the LP-WUR detecting the LP-WUS.

Some aspects described herein relate to an apparatus for wireless communication. The apparatus may include means for receiving, from a network node, information configuring a hopping pattern for monitoring an LP-WUS based at least in part on one or more characteristics associated with the apparatus. The apparatus may include means for monitoring a WUS for the LP-WUS based at least in part on the hopping pattern. The apparatus may include means for waking a main radio from a deep sleep state based at least in part on the means for monitoring detecting the LP-WUS.

Aspects generally include a method, apparatus, system, computer program product, non-transitory computer-readable medium, user equipment, base station, network entity, network node, wireless communication device, and/or processing system as substantially described herein with reference to and as illustrated by the drawings and specification.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages, will be better understood from the following description when considered in connection with the accompanying figures. Each of the figures is provided for the purposes of illustration and description, and not as a definition of the limits of the claims.

While aspects are described in the present disclosure by illustration to some examples, those skilled in the art will understand that such aspects may be implemented in many different arrangements and scenarios. Techniques described herein may be implemented using different platform types, devices, systems, shapes, sizes, and/or packaging arrangements. For example, some aspects may be implemented via integrated chip embodiments or other non-module-component based devices (e.g., end-user devices, vehicles, communication devices, computing devices, industrial equipment, retail/purchasing devices, medical devices, and/or artificial intelligence devices). Aspects may be implemented in chip-level components, modular components, non-modular components, non-chip-level components, device-level components, and/or system-level components. Devices incorporating described aspects and features may include additional components and features for implementation and practice of claimed and described aspects. For example, transmission and reception of wireless signals may include one or more components for analog and digital purposes (e.g., hardware components including antennas, radio frequency (RF) chains, power amplifiers, modulators, buffers, processors, interleavers, adders, and/or summers). It is intended that aspects described herein may be practiced in a wide variety of devices, components, systems, distributed arrangements, and/or end-user devices of varying size, shape, and constitution.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 is a diagram illustrating an example of a wireless network, in accordance with the present disclosure.

FIG. 2 is a diagram illustrating an example of a network node in communication with a user equipment (UE) in a wireless network, in accordance with the present disclosure.

FIG. 3 is a diagram illustrating an example of a low power wakeup receiver (LP-WUR) and a low power wakeup signal (LP-WUS), in accordance with the present disclosure.

FIG. 4 is a diagram illustrating an example of UE grouping to mitigate false alarms causing false main radio wakeup, in accordance with the present disclosure.

FIGS. 5A-5C are diagrams illustrating examples associated with dynamic UE grouping for LP-WUS monitoring, in accordance with the present disclosure.

FIG. 6 is a diagram illustrating an example process associated with dynamic UE grouping for LP-WUS monitoring, in accordance with the present disclosure.

FIG. 7 is a diagram of an example apparatus for wireless communication, in accordance with the present disclosure.

### DETAILED DESCRIPTION

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. One skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

Several aspects of telecommunication systems will now be presented with reference to various apparatuses and techniques. These apparatuses and techniques will be described in the following detailed description and illustrated in the accompanying drawings by various blocks, modules, components, circuits, steps, processes, algorithms, or the like (collectively referred to as “elements”). These elements may be implemented using hardware, software, or combinations thereof. Whether such elements are implemented as hardware or software depends upon the particular application and design constraints imposed on the overall system.

While aspects may be described herein using terminology commonly associated with a 5G or New Radio (NR) radio access technology (RAT), aspects of the present disclosure can be applied to other RATs, such as a 3G RAT, a 4G RAT, and/or a RAT subsequent to 5G (e.g., 6G).

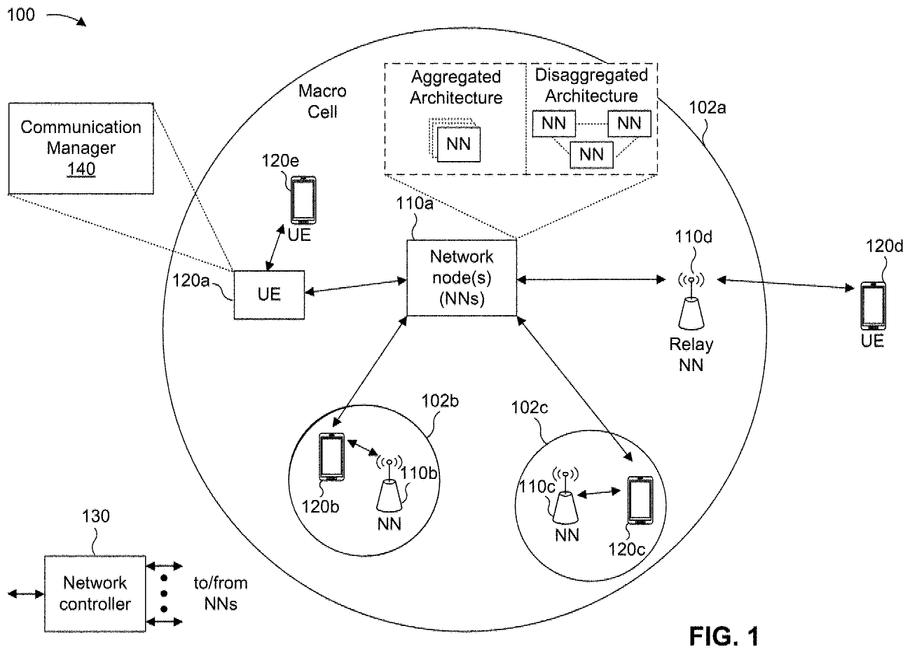

FIG. 1 is a diagram illustrating an example of a wireless network 100, in accordance with the present disclosure. The wireless network 100 may be or may include elements of a 5G (e.g., NR) network and/or a 4G (e.g., Long Term Evolution (LTE)) network, among other examples. The wireless network 100 may include one or more network nodes 110 (shown as a network node 110a, a network node 110b, a network node 110c, and a network node 110d), a user equipment (UE) 120 or multiple UEs 120 (shown as a UE 120a, a UE 120b, a UE 120c, a UE 120d, and a UE 120e), and/or other entities. A network node 110 is a network node that communicates with UEs 120. As shown, a network node 110 may include one or more network nodes. For example, a network node 110 may be an aggregated network node, meaning that the aggregated network node is configured to utilize a radio protocol stack that is physically or logically integrated within a single radio access network (RAN) node (e.g., within a single device or unit). As another example, a network node 110 may be a disaggregated network node (sometimes referred to as a disaggregated base station), meaning that the network node 110 is configured to utilize a protocol stack that is physically or logically distributed among two or more nodes (such as one or more central units (CUs), one or more distributed units (DUs), or one or more radio units (RUs)).

In some examples, a network node 110 is or includes a network node that communicates with UEs 120 via a radio access link, such as an RU. In some examples, a network node 110 is or includes a network node that communicates with other network nodes 110 via a fronthaul link or a midhaul link, such as a DU. In some examples, a network node 110 is or includes a network node that communicates with other network nodes 110 via a midhaul link or a core network via a backhaul link, such as a CU. In some examples, a network node 110 (such as an aggregated network node 110 or a disaggregated network node 110) may include multiple network nodes, such as one or more RUs, one or more CUs, and/or one or more DUs. A network node 110 may include, for example, an NR base station, an LTE base station, a Node B, an eNB (e.g., in 4G), a gNB (e.g., in 5G), an access point, a transmission reception point (TRP), a DU, an RU, a CU, a mobility element of a network, a core network node, a network element, a network equipment, a RAN node, or a combination thereof. In some examples, the network nodes 110 may be interconnected to one another or to one or more other network nodes 110 in the wireless network 100 through various types of fronthaul, midhaul, and/or backhaul interfaces, such as a direct physical connection, an air interface, or a virtual network, using any suitable transport network.

In some examples, a network node 110 may provide communication coverage for a particular geographic area. In the Third Generation Partnership Project (3GPP), the term “cell” can refer to a coverage area of a network node 110 and/or a network node subsystem serving this coverage area, depending on the context in which the term is used. A network node 110 may provide communication coverage for a macro cell, a pico cell, a femto cell, and/or another type of cell. A macro cell may cover a relatively large geographic area (e.g., several kilometers in radius) and may allow unrestricted access by UEs 120 with service subscriptions. A pico cell may cover a relatively small geographic area and may allow unrestricted access by UEs 120 with service subscriptions. A femto cell may cover a relatively small geographic area (e.g., a home) and may allow restricted access by UEs 120 having association with the femto cell (e.g., UEs 120 in a closed subscriber group (CSG)). A network node 110 for a macro cell may be referred to as a macro network node. A network node 110 for a pico cell may be referred to as a pico network node. A network node 110 for a femto cell may be referred to as a femto network node or an in-home network node. In the example shown in FIG. 1, the network node 110a may be a macro network node for a macro cell 102a, the network node 110b may be a pico network node for a pico cell 102b, and the network node 110c may be a femto network node for a femto cell 102c. A network node may support one or multiple (e.g., three) cells. In some examples, a cell may not necessarily be stationary, and the geographic area of the cell may move according to the location of a network node 110 that is mobile (e.g., a mobile network node).

In some aspects, the terms “base station” or “network node” may refer to an aggregated base station, a disaggregated base station, an integrated access and backhaul (IAB) node, a relay node, or one or more components thereof. For example, in some aspects, “base station” or “network node” may refer to a CU, a DU, an RU, a Near-Real Time (Near-RT) RAN Intelligent Controller (RIC), or a Non-Real Time (Non-RT) RIC, or a combination thereof. In some aspects, the terms “base station” or “network node” may refer to one device configured to perform one or more functions, such as those described herein in connection with the network node 110. In some aspects, the terms “base station” or “network node” may refer to a plurality of devices configured to perform the one or more functions. For example, in some distributed systems, each of a quantity of different devices (which may be located in the same geographic location or in different geographic locations) may be configured to perform at least a portion of a function, or to duplicate performance of at least a portion of the function, and the terms “base station” or “network node” may refer to any one or more of those different devices. In some aspects, the terms “base station” or “network node” may refer to one or more virtual base stations or one or more virtual base station functions. For example, in some aspects, two or more base station functions may be instantiated on a single device. In some aspects, the terms “base station” or “network node” may refer to one of the base station functions and not another. In this way, a single device may include more than one base station.

The wireless network 100 may include one or more relay stations. A relay station is a network node that can receive a transmission of data from an upstream node (e.g., a network node 110 or a UE 120) and send a transmission of the data to a downstream node (e.g., a UE 120 or a network node 110). A relay station may be a UE 120 that can relay transmissions for other UEs 120. In the example shown in FIG. 1, the network node 110d (e.g., a relay network node) may communicate with the network node 110a (e.g., a macro network node) and the UE 120d in order to facilitate communication between the network node 110a and the UE 120d. A network node 110 that relays communications may be referred to as a relay station, a relay base station, a relay network node, a relay node, a relay, or the like.

The wireless network 100 may be a heterogeneous network that includes network nodes 110 of different types, such as macro network nodes, pico network nodes, femto network nodes, relay network nodes, or the like. These different types of network nodes 110 may have different transmit power levels, different coverage areas, and/or different impacts on interference in the wireless network 100. For example, macro network nodes may have a high transmit power level (e.g., 5 to 40 watts) whereas pico network nodes, femto network nodes, and relay network nodes may have lower transmit power levels (e.g., 0.1 to 2 watts).

A network controller 130 may couple to or communicate with a set of network nodes 110 and may provide coordination and control for these network nodes 110. The network controller 130 may communicate with the network nodes 110 via a backhaul communication link or a midhaul communication link. The network nodes 110 may communicate with one another directly or indirectly via a wireless or wireline backhaul communication link. In some aspects, the network controller 130 may be a CU or a core network device, or may include a CU or a core network device.

The UEs 120 may be dispersed throughout the wireless network 100, and each UE 120 may be stationary or mobile. A UE 120 may include, for example, an access terminal, a terminal, a mobile station, and/or a subscriber unit. A UE 120 may be a cellular phone (e.g., a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device, a biometric device, a wearable device (e.g., a smart watch, smart clothing, smart glasses, a smart wristband, smart jewelry (e.g., a smart ring or a smart bracelet)), an entertainment device (e.g., a music device, a video device, and/or a satellite radio), a vehicular component or sensor, a smart meter/sensor, industrial manufacturing equipment, a global positioning system device, a UE function of a network node, and/or any other suitable device that is configured to communicate via a wireless or wired medium.

Some UEs 120 may be considered machine-type communication (MTC) or evolved or enhanced machine-type communication (eMTC) UEs. An MTC UE and/or an eMTC UE may include, for example, a robot, a drone, a remote device, a sensor, a meter, a monitor, and/or a location tag, that may communicate with a network node, another device (e.g., a remote device), or some other entity. Some UEs 120 may be considered Internet-of-Things (IoT) devices, and/or may be implemented as NB-IoT (narrowband IoT) devices. Some UEs 120 may be considered a Customer Premises Equipment. A UE 120 may be included inside a housing that houses components of the UE 120, such as processor components and/or memory components. In some examples, the processor components and the memory components may be coupled together. For example, the processor components (e.g., one or more processors) and the memory components (e.g., a memory) may be operatively coupled, communicatively coupled, electronically coupled, and/or electrically coupled.

In general, any number of wireless networks 100 may be deployed in a given geographic area. Each wireless network 100 may support a particular RAT and may operate on one or more frequencies. A RAT may be referred to as a radio technology, an air interface, or the like. A frequency may be referred to as a carrier, a frequency channel, or the like. Each frequency may support a single RAT in a given geographic area in order to avoid interference between wireless networks of different RATs. In some cases, NR or 5G RAT networks may be deployed.

In some examples, two or more UEs 120 (e.g., shown as UE 120a and UE 120e) may communicate directly using one or more sidelink channels (e.g., without using a network node 110 as an intermediary to communicate with one another). For example, the UEs 120 may communicate using peer-to-peer (P2P) communications, device-to-device (D2D) communications, a vehicle-to-everything (V2X) protocol (e.g., which may include a vehicle-to-vehicle (V2V) protocol, a vehicle-to-infrastructure (V2I) protocol, or a vehicle-to-pedestrian (V2P) protocol), and/or a mesh network. In such examples, a UE 120 may perform scheduling operations, resource selection operations, and/or other operations described elsewhere herein as being performed by the network node 110.

Devices of the wireless network 100 may communicate using the electromagnetic spectrum, which may be subdivided by frequency or wavelength into various classes, bands, channels, or the like. For example, devices of the wireless network 100 may communicate using one or more operating bands. In 5G NR, two initial operating bands have been identified as frequency range designations FR1 (410 MHz-7.125 GHz) and FR2 (24.25 GHz-52.6 GHz). It should be understood that although a portion of FR1 is greater than 6 GHZ, FR1 is often referred to (interchangeably) as a “Sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHZ-24.25 GHZ). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR4a or FR4-1 (52.6 GHZ-71 GHz), FR4 (52.6 GHz-114.25 GHZ), and FR5 (114.25 GHZ-300 GHz). Each of these higher frequency bands falls within the EHF band.

With the above examples in mind, unless specifically stated otherwise, it should be understood that the term “sub-6 GHz” or the like, if used herein, may broadly represent frequencies that may be less than 6 GHz, may be within FR1, or may include mid-band frequencies. Further, unless specifically stated otherwise, it should be understood that the term “millimeter wave” or the like, if used herein, may broadly represent frequencies that may include mid-band frequencies, may be within FR2, FR4, FR4-a or FR4-1, and/or FR5, or may be within the EHF band. It is contemplated that the frequencies included in these operating bands (e.g., FR1, FR2, FR3, FR4, FR4-a, FR4-1, and/or FR5) may be modified, and techniques described herein are applicable to those modified frequency ranges.

In some aspects, the UE 120 may include a communication manager 140. As described in more detail elsewhere herein, the communication manager 140 may receive, from a network node, information configuring a hopping pattern for monitoring a low-power wakeup signal (LP-WUS) based at least in part on one or more characteristics associated with the UE 120; monitor, using a low-power wakeup receiver (LP-WUR), a wakeup signal (WUS) for the LP-WUS based at least in part on the hopping pattern; and wake a main radio from a deep sleep state based at least in part on the LP-WUR detecting the LP-WUS. Additionally, or alternatively, the communication manager 140 may perform one or more other operations described herein.

As indicated above, FIG. 1 is provided as an example. Other examples may differ from what is described with regard to FIG. 1.

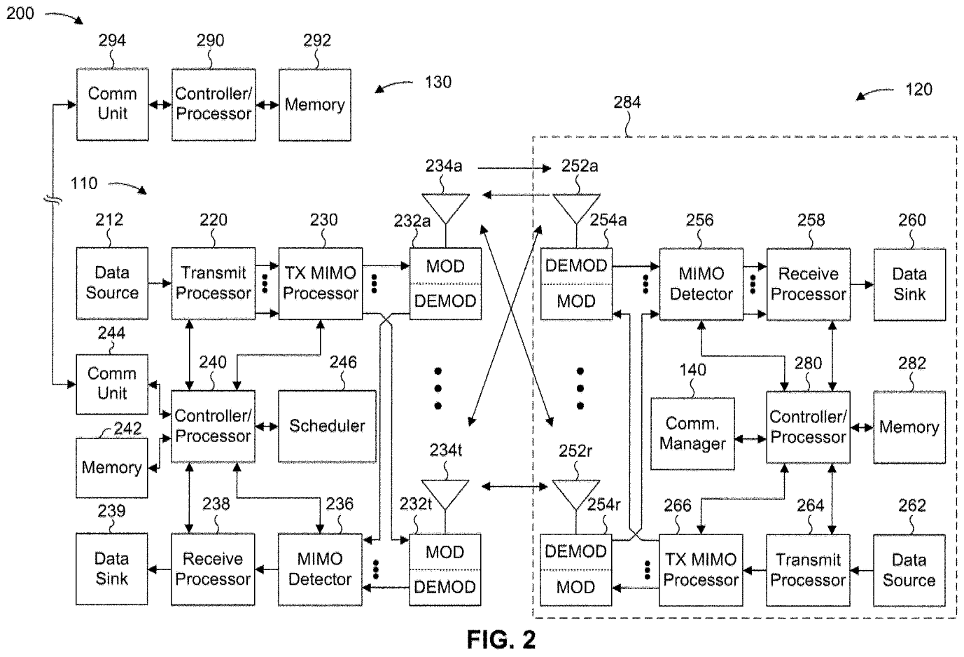

FIG. 2 is a diagram illustrating an example 200 of a network node 110 in communication with a UE 120 in a wireless network 100, in accordance with the present disclosure. The network node 110 may be equipped with a set of antennas 234a through 234t, such as T antennas (T≥1). The UE 120 may be equipped with a set of antennas 252a through 252r, such as R antennas (R≥1). The network node 110 of example 200 includes one or more radio frequency components, such as antennas 234 and a modem 232. In some examples, a network node 110 may include an interface, a communication component, or another component that facilitates communication with the UE 120 or another network node. Some network nodes 110 may not include radio frequency components that facilitate direct communication with the UE 120, such as one or more CUs, or one or more DUs.

At the network node 110, a transmit processor 220 may receive data, from a data source 212, intended for the UE 120 (or a set of UEs 120). The transmit processor 220 may select one or more modulation and coding schemes (MCSs) for the UE 120 based at least in part on one or more channel quality indicators (CQIs) received from that UE 120. The network node 110 may process (e.g., encode and modulate) the data for the UE 120 based at least in part on the MCS(s) selected for the UE 120 and may provide data symbols for the UE 120. The transmit processor 220 may process system information (e.g., for semi-static resource partitioning information (SRPI)) and control information (e.g., CQI requests, grants, and/or upper layer signaling) and provide overhead symbols and control symbols. The transmit processor 220 may generate reference symbols for reference signals (e.g., a cell-specific reference signal (CRS) or a demodulation reference signal (DMRS)) and synchronization signals (e.g., a primary synchronization signal (PSS) or a secondary synchronization signal (SSS)). A transmit (TX) multiple-input multiple-output (MIMO) processor 230 may perform spatial processing (e.g., precoding) on the data symbols, the control symbols, the overhead symbols, and/or the reference symbols, if applicable, and may provide a set of output symbol streams (e.g., T output symbol streams) to a corresponding set of modems 232 (e.g., T modems), shown as modems 232a through 232t. For example, each output symbol stream may be provided to a modulator component (shown as MOD) of a modem 232. Each modem 232 may use a respective modulator component to process a respective output symbol stream (e.g., for OFDM) to obtain an output sample stream. Each modem 232 may further use a respective modulator component to process (e.g., convert to analog, amplify, filter, and/or upconvert) the output sample stream to obtain a downlink signal. The modems 232a through 232t may transmit a set of downlink signals (e.g., T downlink signals) via a corresponding set of antennas 234 (e.g., T antennas), shown as antennas 234a through 234t.

At the UE 120, a set of antennas 252 (shown as antennas 252a through 252r) may receive the downlink signals from the network node 110 and/or other network nodes 110 and may provide a set of received signals (e.g., R received signals) to a set of modems 254 (e.g., R modems), shown as modems 254a through 254r. For example, each received signal may be provided to a demodulator component (shown as DEMOD) of a modem 254. Each modem 254 may use a respective demodulator component to condition (e.g., filter, amplify, downconvert, and/or digitize) a received signal to obtain input samples. Each modem 254 may use a demodulator component to further process the input samples (e.g., for OFDM) to obtain received symbols. A MIMO detector 256 may obtain received symbols from the modems 254, may perform MIMO detection on the received symbols if applicable, and may provide detected symbols. A receive processor 258 may process (e.g., demodulate and decode) the detected symbols, may provide decoded data for the UE 120 to a data sink 260, and may provide decoded control information and system information to a controller/processor 280. The term “controller/processor” may refer to one or more controllers, one or more processors, or a combination thereof. A channel processor may determine a reference signal received power (RSRP) parameter, a received signal strength indicator (RSSI) parameter, a reference signal received quality (RSRQ) parameter, and/or a CQI parameter, among other examples. In some examples, one or more components of the UE 120 may be included in a housing 284.

The network controller 130 may include a communication unit 294, a controller/processor 290, and a memory 292. The network controller 130 may include, for example, one or more devices in a core network. The network controller 130 may communicate with the network node 110 via the communication unit 294.

One or more antennas (e.g., antennas 234a through 234t and/or antennas 252a through 252r) may include, or may be included within, one or more antenna panels, one or more antenna groups, one or more sets of antenna elements, and/or one or more antenna arrays, among other examples. An antenna panel, an antenna group, a set of antenna elements, and/or an antenna array may include one or more antenna elements (within a single housing or multiple housings), a set of coplanar antenna elements, a set of non-coplanar antenna elements, and/or one or more antenna elements coupled to one or more transmission and/or reception components, such as one or more components of FIG. 2.

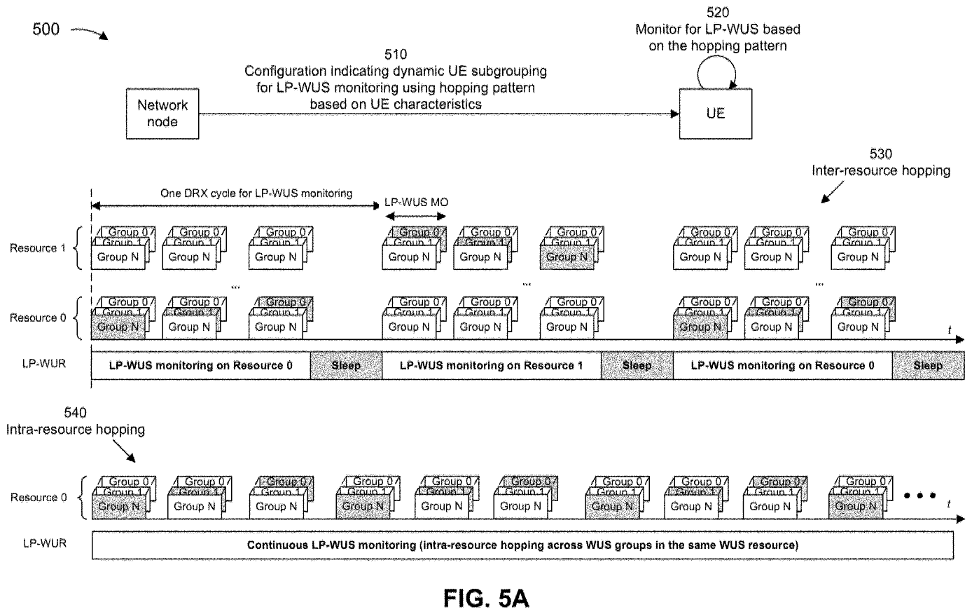

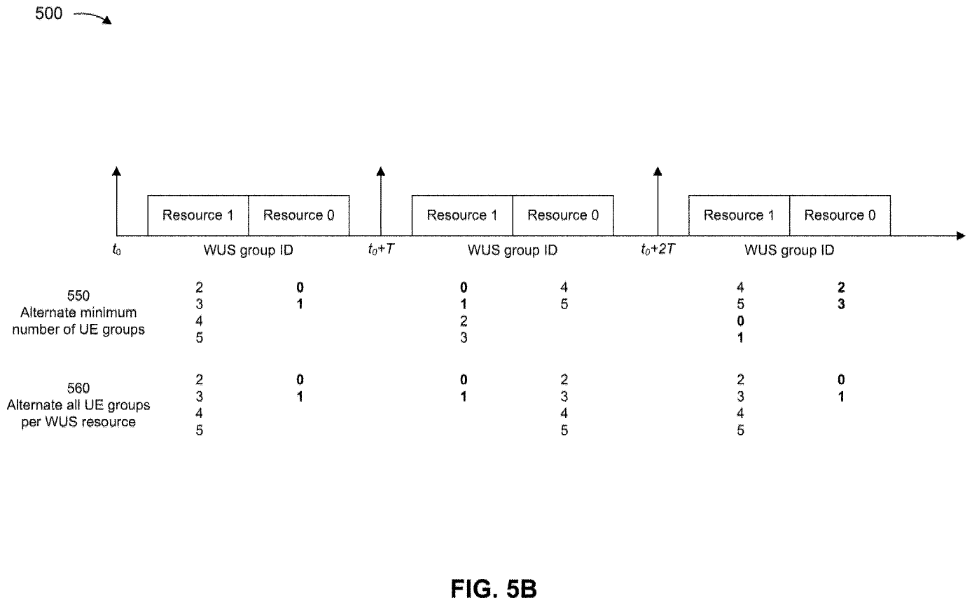

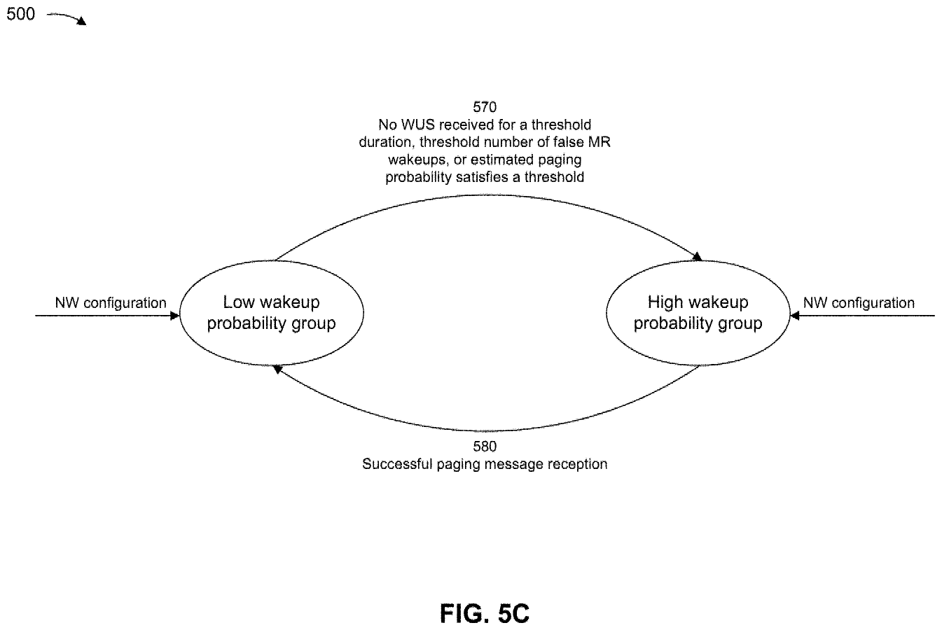

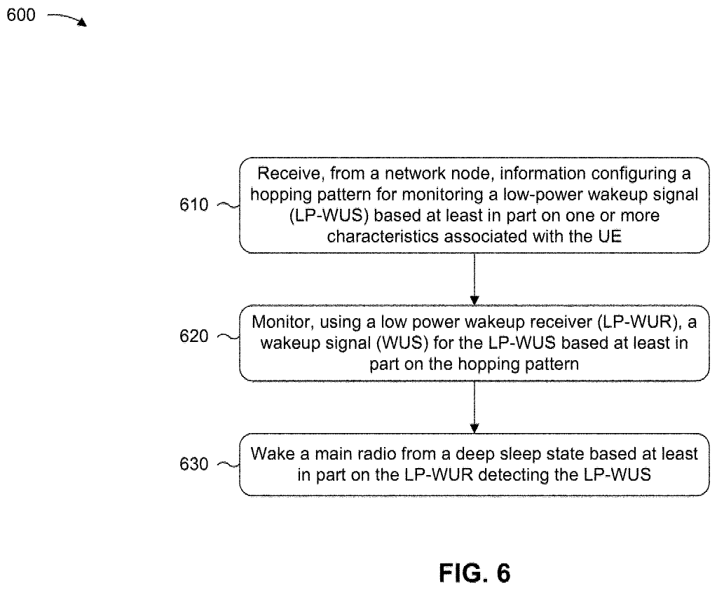

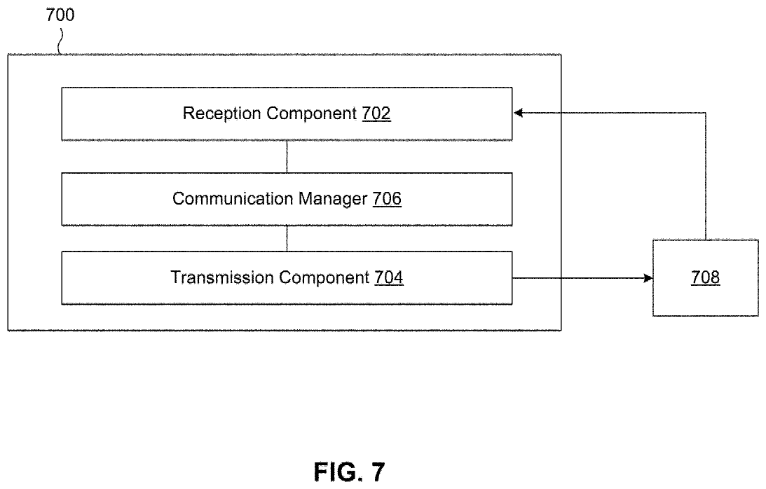

On the uplink, at the UE 120, a transmit processor 264 may receive and process data from a data source 262 and control information (e.g., for reports that include RSRP, RSSI, RSRQ, and/or CQI) from the controller/processor 280. The transmit processor 264 may generate reference symbols for one or more reference signals. The symbols from the transmit processor 264 may be precoded by a TX MIMO processor 266 if applicable, further processed by the modems 254 (e.g., for DFT-s-OFDM or CP-OFDM), and transmitted to the network node 110. In some examples, the modem 254 of the UE 120 may include a modulator and a demodulator. In some examples, the UE 120 includes a transceiver. The transceiver may include any combination of the antenna(s) 252, the modem(s) 254, the MIMO detector 256, the receive processor 258, the transmit processor 264, and/or the TX MIMO processor 266. The transceiver may be used by a processor (e.g., the controller/processor 280) and the memory 282 to perform aspects of any of the methods described herein (e.g., with reference to FIGS. 5A-5C, FIG. 6, and/or FIG. 7).

At the network node 110, the uplink signals from UE 120 and/or other UEs may be received by the antennas 234, processed by the modem 232 (e.g., a demodulator component, shown as DEMOD, of the modem 232), detected by a MIMO detector 236 if applicable, and further processed by a receive processor 238 to obtain decoded data and control information sent by the UE 120. The receive processor 238 may provide the decoded data to a data sink 239 and provide the decoded control information to the controller/processor 240. The network node 110 may include a communication unit 244 and may communicate with the network controller 130 via the communication unit 244. The network node 110 may include a scheduler 246 to schedule one or more UEs 120 for downlink and/or uplink communications. In some examples, the modem 232 of the network node 110 may include a modulator and a demodulator. In some examples, the network node 110 includes a transceiver. The transceiver may include any combination of the antenna(s) 234, the modem(s) 232, the MIMO detector 236, the receive processor 238, the transmit processor 220, and/or the TX MIMO processor 230. The transceiver may be used by a processor (e.g., the controller/processor 240) and the memory 242 to perform aspects of any of the methods described herein (e.g., with reference to FIGS. 5A-5C, FIG. 6, and/or FIG. 7).

The controller/processor 240 of the network node 110, the controller/processor 280 of the UE 120, and/or any other component(s) of FIG. 2 may perform one or more techniques associated with dynamic UE grouping for LP-WUS monitoring, as described in more detail elsewhere herein. For example, the controller/processor 240 of the network node 110, the controller/processor 280 of the UE 120, and/or any other component(s) of FIG. 2 may perform or direct operations of, for example, process 600 of FIG. 6 and/or other processes as described herein. The memory 242 and the memory 282 may store data and program codes for the network node 110 and the UE 120, respectively. In some examples, the memory 242 and/or the memory 282 may include a non-transitory computer-readable medium storing one or more instructions (e.g., code and/or program code) for wireless communication. For example, the one or more instructions, when executed (e.g., directly, or after compiling, converting, and/or interpreting) by one or more processors of the network node 110 and/or the UE 120, may cause the one or more processors, the UE 120, and/or the network node 110 to perform or direct operations of, for example, process 600 of FIG. 6 and/or other processes as described herein. In some examples, executing instructions may include running the instructions, converting the instructions, compiling the instructions, and/or interpreting the instructions, among other examples.

In some aspects, the UE 120 includes means for receiving, from a network node 110, information configuring a hopping pattern for monitoring an LP-WUS based at least in part on one or more characteristics associated with the UE 120; means for monitoring a WUS for the LP-WUS based at least in part on the hopping pattern; and/or means for waking a main radio from a deep sleep state based at least in part on the means for monitoring detecting the LP-WUS. The means for the UE 120 to perform operations described herein may include, for example, one or more of communication manager 140, antenna 252, modem 254, MIMO detector 256, receive processor 258, transmit processor 264, TX MIMO processor 266, controller/processor 280, or memory 282.

While blocks in FIG. 2 are illustrated as distinct components, the functions described above with respect to the blocks may be implemented in a single hardware, software, or combination component or in various combinations of components. For example, the functions described with respect to the transmit processor 264, the receive processor 258, and/or the TX MIMO processor 266 may be performed by or under the control of the controller/processor 280.

As indicated above, FIG. 2 is provided as an example. Other examples may differ from what is described with regard to FIG. 2.

Deployment of communication systems, such as 5G NR systems, may be arranged in multiple manners with various components or constituent parts. In a 5G NR system, or network, a network node, a network entity, a mobility element of a network, a RAN node, a core network node, a network element, a base station, or a network equipment may be implemented in an aggregated or disaggregated architecture. For example, a base station (such as a Node B (NB), an evolved NB (eNB), an NR base station, a 5G NB, an access point (AP), a TRP, or a cell, among other examples), or one or more units (or one or more components) performing base station functionality, may be implemented as an aggregated base station (also known as a standalone base station or a monolithic base station) or a disaggregated base station. “Network entity” or “network node” may refer to a disaggregated base station, or to one or more units of a disaggregated base station (such as one or more CUs, one or more DUs, one or more RUs, or a combination thereof).

An aggregated base station (e.g., an aggregated network node) may be configured to utilize a radio protocol stack that is physically or logically integrated within a single RAN node (e.g., within a single device or unit). A disaggregated base station (e.g., a disaggregated network node) may be configured to utilize a protocol stack that is physically or logically distributed among two or more units (such as one or more CUs, one or more DUs, or one or more RUs). In some examples, a CU may be implemented within a network node, and one or more DUs may be co-located with the CU, or alternatively, may be geographically or virtually distributed throughout one or multiple other network nodes. The DUs may be implemented to communicate with one or more RUs. Each of the CU, DU, and RU also can be implemented as virtual units, such as a virtual central unit (VCU), a virtual distributed unit (VDU), or a virtual radio unit (VRU), among other examples.

Base station-type operation or network design may consider aggregation characteristics of base station functionality. For example, disaggregated base stations may be utilized in an IAB network, an open radio access network (O-RAN (such as the network configuration sponsored by the O-RAN Alliance)), or a virtualized radio access network (vRAN, also known as a cloud radio access network (C-RAN)) to facilitate scaling of communication systems by separating base station functionality into one or more units that can be individually deployed. A disaggregated base station may include functionality implemented across two or more units at various physical locations, as well as functionality implemented for at least one unit virtually, which can enable flexibility in network design. The various units of the disaggregated base station can be configured for wired or wireless communication with at least one other unit of the disaggregated base station.

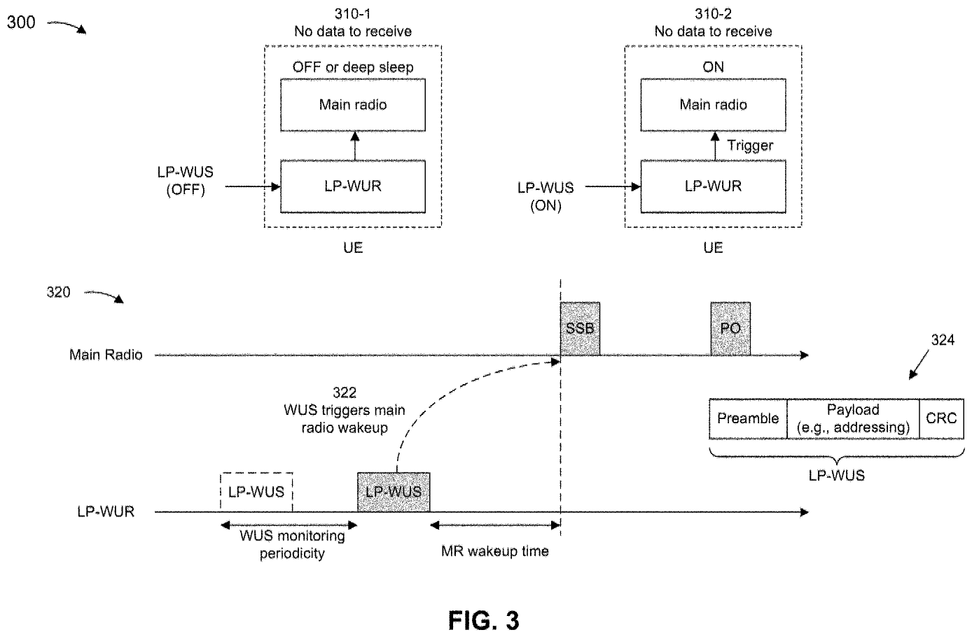

FIG. 3 is a diagram illustrating an example 300 of a low power wakeup receiver (LP-WUR) and an LP-WUS, in accordance with the present disclosure. As shown in FIG. 3, a UE may be equipped with a communication system that includes a main radio (MR) and an LP-WUR to reduce power consumption and enable low latency. For example, power saving and low latency are often conflicting goals because placing one or more components into a sleep state more often to reduce power consumption also increases latency (e.g., because data cannot be transmitted and/or received while the one or more components are in the sleep state). Furthermore, in cases where the time that one or more components spend in a sleep state is reduced to reduce latency, power consumption may increase. Accordingly, as shown in FIG. 3, the UE may be equipped with the LP-WUR, which is a companion receiver that may be used with a MR to reduce power consumption and reduce latency.

For example, in some aspects, the UE may generally use the MR to transmit and/or receive user data, and the MR may be turned off or operated in a deep sleep state (e.g., a power state associated with one (1) relative power unit, as defined in TR 38.840) unless there is user data to transmit and/or receive. Furthermore, the LP-WUR may serve as a simple wakeup receiver for the MR (e.g., the LP-WUR does not include a transmitter), and the LP-WUR may be active and monitoring for an LP-WUS while the MR is off or in the deep sleep state. For example, reference number 310-1 depicts a first state associated with the MR and the LP-WUR in cases where there is no user data that the MR needs to receive. In such cases, the MR may be off or in the deep sleep state unless there is user data to transmit, and the LP-WUR may actively monitor for an LP-WUS (e.g., continuously or periodically in monitoring occasions that are separated in time). Furthermore, reference number 310-2 depicts a second state associated with the MR and the LP-WUR where there is user data that the MR needs to receive. In such cases, the LP-WUR may receive an LP-WUS (e.g., from a network node) and may provide a trigger to wake or otherwise activate the MR based on detecting the LP-WUS. Accordingly, the MR may then transmit and/or receive user data.

In general, the LP-WUR may consume very little power (e.g., a target power consumption less than 100 microwatts (μW) in the active state), which may be achieved using simple modulation schemes (e.g., on-off-keying (OOK)), a narrow bandwidth (e.g., less than 5 MHz), and/or other suitable techniques. In this way, the LP-WUR can be used to reduce the time that the MR spends in an on state and/or may avoid unnecessarily waking the MR from the off or deep sleep state when there is no user data to transmit or receive, which tends to be costly from a power consumption perspective. Furthermore, because the LP-WUR has a very low power consumption, the LP-WUR can be used to frequently or continuously perform LP-WUS monitoring, which may improve latency because the MR can be woken up when there is user data that the MR needs to receive (e.g., the LP-WUR does not suffer from the latency versus power efficiency tradeoff associated with duty cycling schemes, such as discontinuous reception (DRX)). Furthermore, in addition to performing LP-WUS monitoring, which is mainly targeted at paging reception, the LP-WUR may monitor a low power reference signal (LP-RS) for time and frequency tracking and radio resource management (RRM) measurement. In this way, by monitoring the LP-RS, serving cell and/or neighbor cell monitoring can be offloaded from the MR to the LP-WUR to reduce how often the MR is woken up and thereby reduce power consumption.

In some aspects, as shown by reference number 320, one application for the LP-WUR is to monitor the LP-WUS for paging monitoring, which can be used to reduce unnecessary paging reception performed by the MR. For example, as shown in FIG. 3, the LP-WUR may be configured to monitor for an LP-WUS (e.g., while the MR is off or in a deep sleep state) according to a WUS monitoring periodicity (e.g., the LP-WUR may monitor for the LP-WUS in periodic LP-WUS monitoring occasions that are separated in time by the WUS monitoring periodicity). Alternatively, although not explicitly shown in FIG. 3, the LP-WUR may be configured to continuously monitor for the LP-WUS. In general, a network node may transmit an LP-WUS to a UE only in cases where there is a paging message that needs to be sent to the UE while the UE is in an idle or inactive state (e.g., a radio resource control (RRC) idle or RRC inactive state). In such cases, as shown by reference number 322, the LP-WUR may receive and detect the LP-WUS, which may trigger the LP-WUR to wake up the MR. For example, as shown by reference number 324, the LP-WUS may be a message-based WUS, which may correspond to a packet that includes a preamble, a payload (e.g., a cell identifier or UE addressing for a paging early indication), and a cyclic redundancy code (CRC). Alternatively, in some aspects, the LP-WUS may be a sequence-based WUS, which may include a predefined set of sequences that depend on a cell identifier and/or an identifier associated with the UE. In either case, as shown, the MR may wake up after a MR wakeup time, and may then start to monitor one or more synchronization signal block (SSB) transmissions to obtain synchronization with the network node before monitoring and receiving the paging message in a subsequent PO. Otherwise, in cases where the LP-WUR does not detect the LP-WUS, the MR may remain in the deep sleep state to save power.

As indicated above, FIG. 3 is provided as an example. Other examples may differ from what is described with regard to FIG. 3.

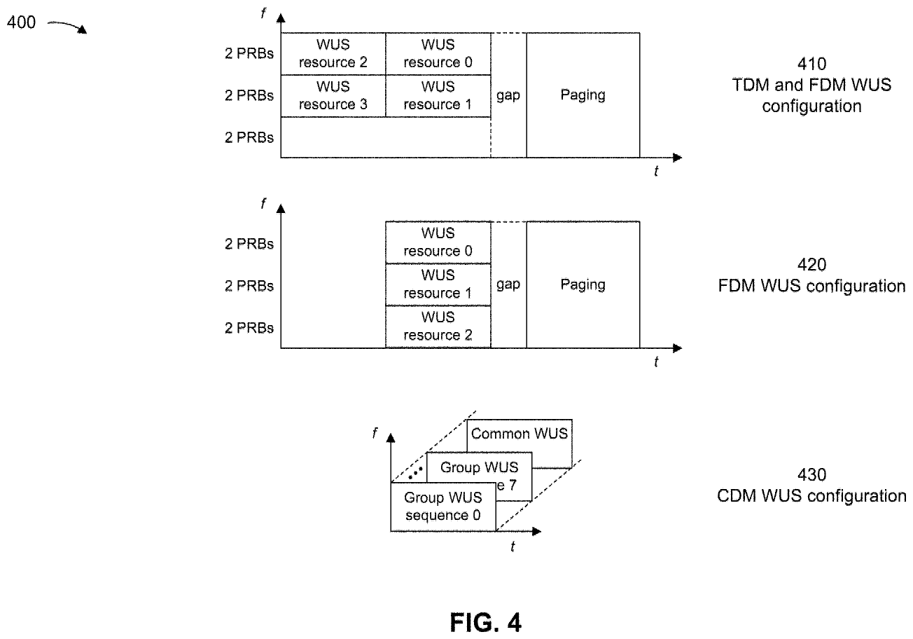

FIG. 4 is a diagram illustrating an example 400 of UE grouping to mitigate false alarms causing false MR wakeup, in accordance with the present disclosure. For example, as described in further detail above with reference to FIG. 3, a UE may be equipped with an LP-WUR that is used as a companion receiver with an MR to reduce power consumption and reduce latency. However, performance of the LP-WUR may be susceptible to false alarm events that may result in the MR being falsely (e.g., mistakenly) woken up from a sleep state. For example, in cases where the LP-WUR is associated with a high false alarm rate, the false alarm rate may neutralize any power saving benefit otherwise offered by the LP-WUR, or may actually result in increased power consumption because the MR generally consumes considerable energy to ramp up from a deep sleep state and/or to ramp down to the deep sleep state.

In general, there are two false alarm types that may result in the LP-WUR falsely waking the MR from the deep sleep state. For example, a first false alarm type may occur when the LP-WUR incorrectly detects an LP-WUS even though the LP-WUS was not actually transmitted by a network node. Alternatively, a second false alarm type may occur when a network node transmits an LP-WUS to one UE, and the LP-WUS unnecessarily wakes the MR on other UEs that share the same WUS resource. In some cases, the first false alarm type (e.g., where an LP-WUR incorrectly detects an LP-WUS that was not transmitted) may be mitigated or otherwise reduced by using physical layer (PHY) techniques, such as a CRC. Furthermore, in some cases, the second false alarm type (e.g., where an LP-WUS transmitted to an intended UE incorrectly wakes other UEs sharing the same resource) may be mitigated or reduced by using a UE subgrouping to reduce the rise of false paging to other UEs in the same paging occasion (PO). For example, in a wireless network that supports a paging early indication (PEI), UEs that are configured to monitor the same PO can be divided into one or more subgroups based on a core network assignment or a UE identifier. Additionally, or alternatively, in enhanced MTC (eMTC) communications, a group WUS may be used to simultaneously wake a group of UEs using group WUS resources associated with a time division multiplexing (TDM), frequency division multiplexing (FDM), and/or code division multiplexing (CDM) configuration.

For example, referring to FIG. 4, reference number 410 depicts a group WUS configuration that includes four (4) WUS resources associated with a TDM and FDM configuration. As shown in FIG. 4, the WUS resources associated with a TDM and FDM configuration may include multiple WUS resources that are associated with separate resources in a time domain and/or a frequency domain, where each WUS resource may be associated with a UE group that includes one or more UEs. Furthermore, a gap may be provided between the WUS resources and a PO that a UE is to monitor in cases where a WUS is detected in the WUS resource associated with the UE group that includes the UE. Alternatively, reference number 420 depicts a group WUS configuration that includes three (3) WUS resources associated with an FDM configuration. As shown in FIG. 4, the WUS resources associated with the FDM configuration may include multiple WUS resources that occupy the same resources in a time domain and separate resources in a frequency domain, where each WUS resource may be associated with a UE group that includes one or more UEs. Furthermore, in a similar manner as the group WUS configuration associated with the TDM and FDM configuration, a gap may be provided between the WUS resources and a PO that a UE is to monitor in cases where a WUS is detected in the monitored WUS resource.

Alternatively, reference number 430 depicts a group WUS configuration that includes multiple group WUSs associated with a CDM configuration. As shown in FIG. 4, the multiple group WUSs may each be associated with a respective CDM sequence, and the multiple group WUSs may occupy the same resources in time and frequency domains. In the case of WUS resources with a CDM configuration, there may be up to eight (8) UE group WUS sequences per WUS resource.

Accordingly, as described herein, a group WUS configuration may be used to reduce false alarms in which the LP-WUR incorrectly wakes the MR when an LP-WUS intended to wake one UE unnecessarily wakes other UEs sharing the same group WUS resource. However, current techniques for determining the UE grouping tend to be semi-static and determined based on a core network assignment or a UE identifier. For example, in cases where the UE grouping is semi-statically determined based on a core network assignment, the UE is typically assigned a subgroup identifier by an access and mobility management function (AMF) through non-access stratum (NAS) signaling. Alternatively, in cases where the UE grouping is determined based on a UE identifier, a UE determines the subgroup identifier using the following formula:

$$“ Y {o}^{′} {ω}^{\tilde{’}} ” Ω {ι}^{‵} {ε}^{′} {o}^{′} {η}^{‵} “ 0 ’ O \frac{\tilde{‘} Y ‘ Ο}{{U}^{″} {U}^{″} {ι}^{′}} {α}^{′} {ε}^{′} ’ Ω {ι}^{′} {o}^{′} {ω}^{\tilde{‘}} “ Ω {ι}^{‵} {ε}^{′} {o}^{′} {η}^{‵} {ι}^{′} {U}^{″} {o}^{′} {α}^{′} “ 0 {ε}^{′} {ι}^{‵} \tilde{‘} Y ‘ O “ 0 ’ O$$

where N and Ns are parameters to calculate a paging frame and a paging occasion, and the same value of [symbol] indicates UEs that share the same PO.

Although eMTC communications currently UE subgroup hopping for a group WUS (e.g., changing a group WUS that is monitored for a WUS in successive monitoring occasions), the hopping configuration is typically cell-specific and uses the same hopping offset and periodicity for all UEs. For example, UE subgroup hopping may be configured per DRX cycle and/or per paging cycle with a fixed hopping offset. Accordingly, techniques that use a semi-static UE subgrouping or a cell-specific UE subgroup hopping pattern are unable to resolve UE collision issues (e.g., false alarms where a WUS intended for one UE unnecessarily wakes other UEs) because two UEs that collide in a particular UE subgroup are still in the same UE subgroup after the hopping pattern is applied. For example, in cases where two UEs have different traffic arrival rates and different paging probabilities, a first UE with a low paging probability may be frequently subject to false alarms causing the first UE to wake up based on a WUS transmitted to another UE in the same subgroup that has a high paging probability. Furthermore, even in cases where different UEs in the same UE subgroup have the same paging probability, WUS monitoring is subject to DRX operation, which can cause the paging probability to be different for each WUS monitoring occasion and/or for different DRX periodicities. For example, in cases where extended DRX (eDRX) is configured, a higher paging probability may be assumed for a first idle mode DRX (I-DRX) cycle within a paging time window (PTW), and a lower paging probability may be assumed for each of the remaining I-DRX cycles within the PTW.

As indicated above, FIG. 4 is provided as an example. Other examples may differ from what is described with regard to FIG. 4.

FIGS. 5A-5C are diagrams illustrating examples 500 associated with dynamic UE grouping for LP-WUS monitoring, in accordance with the present disclosure. As shown in FIG. 5A, examples 500 include communication between a network node (e.g., network node 110) and a UE (e.g., UE 120). In some aspects, the network node and the UE may be included in a wireless network, such as wireless network 100. The network node and the UE may communicate via a wireless access link, which may include an uplink and a downlink. Furthermore, as described in further detail elsewhere herein, the UE may be equipped with an MR and an LP-WUR.

As shown in FIG. 5A, and by reference number 510, the network node may transmit, and the UE may receive, information that includes a configuration to indicate a dynamic UE subgrouping for LP-WUS monitoring using a hopping pattern that is based on individual UE characteristics. For example, in some aspects, the individual UE characteristics may include a UE type (e.g., a category based on one or more UE capabilities, such as eMBB, reduced capability (RedCap), or non-RedCap), a UE traffic pattern, a UE paging probability, an LP-WUS monitoring scheme, an LP-WUS configuration, or the like. For example, UEs that have the same or similar paging probabilities may have the same hopping pattern in terms of a hopping interval and offset such that the UEs with the same or similar paging probabilities are in the same UE subgroups for LP-WUS monitoring. In another example, when duty cycle operation (e.g., DRX) is used for LP-WUS monitoring, UEs that are in the same UE subgroup may have the same LP-WUS monitoring periodicity and time offset. As described herein, the hopping pattern may generally include an LP-WUS hopping time interval and/or an LP-WUS hopping offset for each UE subgroup, and the UE may dynamically determine the UE subgroup that includes the UE in each LP-WUS monitoring occasion.

Accordingly, as further shown in FIG. 5A, and by reference number 520, the UE may monitor, using the LP-WUR, an LP-WUS resource based on the hopping pattern. For example, the configuration information that the UE receives from the network node may include an LP-WUS group set that includes one or more WUS groups associated with the same WUS resource or different WUS resources. For example, the LP-WUS group set can be provided via the MR in an RRC connection release message that the network node transmits to the UE when the UE is transitioned to an RRC inactive state, or the LP-WUS group set can be provided in system information. In the latter case, where the LP-WUS group set can be provided in system information, the UE may determine the LP-WUS group set associated with the UE based on the paging probability associated with the UE and/or other individual characteristics associated with the UE (e.g., a type associated with the UE, a traffic pattern associated with the UE, an LP-WUS monitoring scheme, or the like). In any case, when the hopping pattern is enabled, the UE may determine an index associated with a WUS group in the LP-WUS group set configured for the UE, and may determine a corresponding LP-WUS resource to monitor for each LP-WUS monitoring occasion. For example, in some aspects, the UE may determine the index associated with the WUS group to be monitored in a current LP-WUS monitoring occasion using the following formula:

$${‶}^{} Ω {o}^{‵} {}^{‶} Ω {U}^{″} \cdot {}^{‶} Ω {α}^{‵} {ε}^{′} {ε}^{′} {ι}^{‵} \frac{“ Y ” O {U}^{″}}{{U}^{\tilde{’}}} {α}^{′} {ε}^{′} ’ Ω {U}^{″}$$

where [symbol] is an initial WUS group assignment that can be assigned by a core network or determined by the UE based on a UE identifier, O is a hopping offset in units of a number of WUS groups, P is a hopping interval, and N is the total number of WUS groups in the LP-WUS group set that the network node configured for the UE.

In some aspects, as described herein, the LP-WUS monitoring scheme may be associated with an inter-resource hopping pattern across multiple WUS resources, or for intra-resource hopping among multiple WUS groups in one WUS resource.

Furthermore, in cases where LP-WUS monitoring is performed in conjunction with a DRX cycle, inter-resource hopping may be used between two DRX cycles and intra-resource hopping may be used in one DRX cycle (e.g., for multiple monitoring occasions that occur in the DRX active time). For example, in FIG. 5A, reference number 530 depicts an inter-resource hopping pattern across multiple WUS resources, including a first WUS resource associated with a first set of WUS groups and a second WUS resource associated with a second set of WUS groups. As shown in FIG. 5A, the UE may perform intra-resource hopping among the WUS groups included in the first WUS resource during the active time of a first DRX cycle before entering a sleep state for the remainder of the first DRX cycle, may perform inter-resource hopping between two DRX cycles thus switching from the first WUS resource to the second WUS resource for LP-WUS monitoring in the second DRX cycle, and may then again perform intra-resource hopping among the WUS groups included in the second WUS resource during the active time of a second DRX cycle before entering a sleep state for the remainder of the second DRX cycle. In cases where an inter-resource hopping pattern is used, different WUS resources may have different frequency domain resource mappings, and switching from one WUS resource to another WUS resource may require radio frequency (RF) retuning for the LP-WUR. Alternatively, for a continuous monitoring scheme (e.g., in contrast to a DRX cycle that includes an inactive time in which the UE enters a sleep state), the UE may be configured to perform intra-resource hopping, or a hopping interval may be defined with the UE performing intra-resource hopping within the hopping interval and intra-resource hopping across different time intervals. For example, reference number 540 depicts an intra-resource hopping pattern among multiple WUS groups in the same WUS resource, where the UE continuously monitors for the LP-WUS in each LP-WUS monitoring occasion and hops between different WUS groups in the same WUS resource.

In some aspects, in cases where an inter-resource hopping pattern is used, the inter-resource hopping pattern may alternate a minimum number of UE groups and maintain the same number of WUS groups per WUS resource before and after the hopping. Alternatively, in some aspects, the inter-resource hopping pattern may alternate all UE groups per WUS resource together. For example, referring to FIG. 5B, reference number 550 depicts an example where an inter-resource hopping pattern alternates a minimum number of UE groups and maintains the same number of WUS groups per WUS resource before and after the hopping. For example, in a first LP-WUS monitoring occasion (e.g., associated with time to), a first WUS resource (shown as resource 1) is monitored by UEs associated with WUS group identifiers {2, 3, 4, 5}, and a second WUS resource (shown as resource 0) is monitored by UEs associated with WUS group identifiers {0, 1}. As further shown, in a second LP-WUS monitoring occasion (e.g., associated with time t₀+T), the first WUS resource is monitored by UEs associated with WUS group identifiers {0, 1, 2, 3} and the second WUS resource is monitored by UEs associated with WUS group identifiers {4, 5}, and in a third LP-WUS monitoring occasion (e.g., associated with time t₀+27), the first WUS resource is monitored by UEs associated with WUS group identifiers {4, 5, 0, 1} and the second WUS resource is monitored by UEs associated with WUS group identifiers {2, 3}. Accordingly, in this case, the number of WUS group identifiers associated with each WUS resource is maintained in each LP-WUS monitoring occasion, and the minimum number of UE groups is alternated (or rotated) in successive LP-WUS monitoring occasions. Alternatively, still referring to FIG. 5B, reference number 560 depicts an example where an inter-resource hopping pattern alternates all UE groups per WUS resource. For example, in the first LP-WUS monitoring occasion (e.g., associated with time to), the first WUS resource is monitored by UEs associated with WUS group identifiers {2, 3, 4, 5} and the second WUS resource is monitored by UEs associated with WUS group identifiers {0, 1}. However, in the second LP-WUS monitoring occasion (e.g., associated with time t₀+T), the first WUS resource is monitored by UEs associated with WUS group identifiers {0, 1} and the second WUS resource is monitored by UEs associated with WUS group identifiers {2, 3, 4, 5}, and in a third LP-WUS monitoring occasion (e.g., associated with time t₀+27), the first WUS resource is again monitored by UEs associated with WUS group identifiers {2, 3, 4, 5} and the second WUS resource is monitored by UEs associated with WUS group identifiers {0, 1}. Accordingly, in this case, the WUS group identifiers are all alternated (or rotated) together among the different WUS resources to be monitored/

In some aspects, as shown in FIG. 5C, the hopping pattern may be based on a received LP-WUS and an estimated paging probability in addition to and/or instead of configuring the hopping pattern based on an absolute single frequency network (SFN). For example, in some aspects, the network node may configure the UE with two or more LP-WUS groups, each of which may be associated with a different paging probability, and the hopping pattern may be supported by the UE alternating or otherwise switching between the different LP-WUS groups. For example, FIG. 5C illustrates a scenario where the UE is configured with a first LP-WUS group associated with a low paging probability and a second LP-WUS group associated with a high paging probability. As shown in FIG. 5C, the UE may initially be assigned to one of the LP-WUS groups based on the paging probability associated with the UE, and the UE may then transition to a different LP-WUS group when one or more conditions are satisfied. For example, reference number 570 depicts a scenario where the UE is assigned to the LP-WUS group with the low paging probability (e.g., based on a network configuration or after a transition out of the LP-WUS group with the high paging probability), in which case the transition to the LP-WUS group with the high paging probability may be triggered when the UE does not receive an LP-WUS within a threshold time period, when the UE falsely or incorrectly wakes up the MR a threshold number of times, and/or when an estimated paging probability for the UE satisfies (e.g., equals or exceeds) a threshold. For example, assuming that the paging probability for the UE at time Tis P, then the paging probability for the UE at time 2T and 4T is 1−(1−P)² and 1−(1−P)⁴, respectively, where T is counted from the last paging message received by the UE. Additionally, or alternatively, reference number 580 depicts a scenario where the UE is assigned to the LP-WUS group with the high paging probability (e.g., based on a network configuration or after a transition out of the LP-WUS group with the low paging probability), in which case the transition to the LP-WUS group with the low paging probability may be triggered when the UE receives a paging message.

In some aspects, in cases where the network node configures the UE to perform dynamic UE subgroup hopping for monitoring WUS resources for an LP-WUS, the hopping pattern may be enabled or disabled semi-statically by one or more bits included in a system information block (SIB) (e.g., a cell-specific SIB to enable or disable intra-resource hopping and/or inter-resource hopping). Additionally, or alternatively, the hopping pattern may be enabled or disabled dynamically by one or more bits included in an LP-WUS (e.g., a UE-specific LP-WUS that is used only to enable or disable intra-resource hopping). In this way, the UE-specific configuration may allow the network node to dynamically assign different UEs to different WUS groups to minimize the overall number of UE false wakeups that occur. For example, in one scenario, a first UE, a second UE, and a third UE may be dynamically assigned to a first WUS group, and a fourth UE and a fifth UE may be dynamically assigned to a second WUS group. In such cases, where there is a paging message to the first UE but no other UEs, the second and third UEs (in the same WUS group as the first UE) would be mistakenly woken up in cases where WUS resource hopping is not enabled. However, if WUS intra-resource hopping is enabled, the first UE and the second UE may be moved to the second WUS group, the fourth and fifth UEs may be moved to the first WUS group, and the third UE may stay in the first WUS group. In such a case, only the second UE is mistakenly woken up, whereby the network node may enable hopping (e.g., in an LP-WUS) to reduce the overall number of UEs that are falsely woken up.

As indicated above, FIGS. 5A-5C are provided as examples. Other examples may differ from what is described with regard to FIGS. 5A-5C.

FIG. 6 is a diagram illustrating an example process 600 performed, for example, by a UE, in accordance with the present disclosure. Example process 600 is an example where the UE (e.g., UE 120) performs operations associated with dynamic UE grouping for LP-WUS monitoring.

As shown in FIG. 6, in some aspects, process 600 may include receiving, from a network node, information configuring a hopping pattern for monitoring an LP-WUS based at least in part on one or more characteristics associated with the UE (block 610). For example, the UE (e.g., using reception component 702 and/or communication manager 706, depicted in FIG. 7) may receive, from a network node, information configuring a hopping pattern for monitoring an LP-WUS based at least in part on one or more characteristics associated with the UE, as described above.

As further shown in FIG. 6, in some aspects, process 600 may include monitoring, using an LP-WUR, a WUS for the LP-WUS based at least in part on the hopping pattern (block 620). For example, the UE (e.g., using communication manager 706, depicted in FIG. 7) may monitor, using an LP-WUR, a WUS for the LP-WUS based at least in part on the hopping pattern, as described above.

As further shown in FIG. 6, in some aspects, process 600 may include waking a main radio from a deep sleep state based at least in part on the LP-WUR detecting the LP-WUS (block 630). For example, the UE (e.g., using communication manager 706, depicted in FIG. 7) may wake a main radio from a deep sleep state based at least in part on the LP-WUR detecting the LP-WUS, as described above.

Process 600 may include additional aspects, such as any single aspect or any combination of aspects described below and/or in connection with one or more other processes described elsewhere herein.

In a first aspect, the one or more characteristics associated with the UE include one or more of a UE type, a traffic pattern, a paging probability, an LP-WUS monitoring scheme, or an LP-WUS configuration associated with the UE.

In a second aspect, alone or in combination with the first aspect, the hopping pattern includes an LP-WUS hopping time interval and an LP-WUS hopping offset.

In a third aspect, alone or in combination with one or more of the first and second aspects, process 600 includes receiving, from the network node, information configuring an LP-WUS group set that includes one or more WUS groups, wherein the one or more WUS groups are associated with one or more WUS resources, and determining, among the one or more WUS groups included in the LP-WUS group set, an index associated with a WUS group, wherein the WUS group associated with the index is monitored for the LP-WUS.

In a fourth aspect, alone or in combination with one or more of the first through third aspects, the hopping pattern is an intra-resource hopping pattern associated with multiple WUS groups in one WUS resource.

In a fifth aspect, alone or in combination with one or more of the first through fourth aspects, the hopping pattern is an inter-resource hopping pattern across multiple WUS resources.

In a sixth aspect, alone or in combination with one or more of the first through fifth aspects, the inter-resource hopping pattern defines a fixed number of WUS groups per WUS resource and alternates among associations between WUS group identifiers and WUS resource identifiers.

In a seventh aspect, alone or in combination with one or more of the first through sixth aspects, the inter-resource hopping pattern defines fixed WUS group identifier groupings that are all alternated together between different WUS resource identifiers.

In an eighth aspect, alone or in combination with one or more of the first through seventh aspects, the hopping pattern includes an inter-resource hopping pattern that is used between two DRX cycles and an intra-resource hopping pattern that is used within one DRX cycle based at least in part on the LP-WUR monitoring for the LP-WUS according to a DRX configuration.

In a ninth aspect, alone or in combination with one or more of the first through eighth aspects, the WUS group that is monitored for the LP-WUS is associated with a first paging probability.

In a tenth aspect, alone or in combination with one or more of the first through ninth aspects, process 600 includes monitoring a WUS group associated with a second paging probability for the LP-WUS based at least in part on one or more conditions being satisfied, wherein the second paging probability is different from the first paging probability.

In an eleventh aspect, alone or in combination with one or more of the first through tenth aspects, the hopping pattern for monitoring the LP-WUS is enabled or disabled by one or more bits included in a SIB.

In a twelfth aspect, alone or in combination with one or more of the first through eleventh aspects, the hopping pattern for monitoring the LP-WUS is enabled or disabled by an indication included in the LP-WUS.

Although FIG. 6 shows example blocks of process 600, in some aspects, process 600 may include additional blocks, fewer blocks, different blocks, or differently arranged blocks than those depicted in FIG. 6. Additionally, or alternatively, two or more of the blocks of process 600 may be performed in parallel.

FIG. 7 is a diagram of an example apparatus 700 for wireless communication, in accordance with the present disclosure. The apparatus 700 may be a UE, or a UE may include the apparatus 700. In some aspects, the apparatus 700 includes a reception component 702, a transmission component 704, and/or a communication manager 706, which may be in communication with one another (for example, via one or more buses and/or one or more other components). In some aspects, the communication manager 706 is the communication manager 140 described in connection with FIG. 1. As shown, the apparatus 700 may communicate with another apparatus 708, such as a UE or a network node (such as a CU, a DU, an RU, or a base station), using the reception component 702 and the transmission component 704.

In some aspects, the apparatus 700 may be configured to perform one or more operations described herein in connection with FIGS. 5A-5C. Additionally, or alternatively, the apparatus 700 may be configured to perform one or more processes described herein, such as process 600 of FIG. 6. In some aspects, the apparatus 700 and/or one or more components shown in FIG. 7 may include one or more components of the UE described in connection with FIG. 2. Additionally, or alternatively, one or more components shown in FIG. 7 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 702 may receive communications, such as reference signals, control information, data communications, or a combination thereof, from the apparatus 708. The reception component 702 may provide received communications to one or more other components of the apparatus 700. In some aspects, the reception component 702 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 700. In some aspects, the reception component 702 may include one or more antennas, a modem, a demodulator, a MIMO detector, a receive processor, a controller/processor, a memory, or a combination thereof, of the UE described in connection with FIG. 2.

The transmission component 704 may transmit communications, such as reference signals, control information, data communications, or a combination thereof, to the apparatus 708. In some aspects, one or more other components of the apparatus 700 may generate communications and may provide the generated communications to the transmission component 704 for transmission to the apparatus 708. In some aspects, the transmission component 704 may perform signal processing on the generated communications (such as filtering, amplification, modulation, digital-to-analog conversion, multiplexing, interleaving, mapping, or encoding, among other examples), and may transmit the processed signals to the apparatus 708. In some aspects, the transmission component 704 may include one or more antennas, a modem, a modulator, a transmit MIMO processor, a transmit processor, a controller/processor, a memory, or a combination thereof, of the UE described in connection with FIG. 2. In some aspects, the transmission component 704 may be co-located with the reception component 702 in a transceiver.

The communication manager 706 may support operations of the reception component 702 and/or the transmission component 704. For example, the communication manager 706 may receive information associated with configuring reception of communications by the reception component 702 and/or transmission of communications by the transmission component 704. Additionally, or alternatively, the communication manager 706 may generate and/or provide control information to the reception component 702 and/or the transmission component 704 to control reception and/or transmission of communications.

The reception component 702 may receive, from a network node, information configuring a hopping pattern for monitoring an LP-WUS based at least in part on one or more characteristics associated with the UE. The communication manager 706 may monitor, using an LP-WUR, a WUS for the LP-WUS based at least in part on the hopping pattern. The communication manager 706 may wake a main radio from a deep sleep state based at least in part on the LP-WUR detecting the LP-WUS

The reception component 702 may receive, from the network node, information configuring an LP-WUS group set that includes one or more WUS groups, wherein the one or more WUS groups are associated with one or more WUS resources. The communication manager 706 may determine, among the one or more WUS groups included in the LP-WUS group set, an index associated with a WUS group, wherein the WUS group associated with the index is monitored for the LP-WUS.

The number and arrangement of components shown in FIG. 7 are provided as an example. In practice, there may be additional components, fewer components, different components, or differently arranged components than those shown in FIG. 7. Furthermore, two or more components shown in FIG. 7 may be implemented within a single component, or a single component shown in FIG. 7 may be implemented as multiple, distributed components. Additionally, or alternatively, a set of (one or more) components shown in FIG. 7 may perform one or more functions described as being performed by another set of components shown in FIG. 7.

The following provides an overview of some Aspects of the present disclosure:
Aspect 1: A method of wireless communication performed by a UE, comprising: receiving, from a network node, information configuring a hopping pattern for monitoring an LP-WUS based at least in part on one or more characteristics associated with the UE; monitoring, using an LP-WUR, a WUS for the LP-WUS based at least in part on the hopping pattern; and waking a main radio from a deep sleep state based at least in part on the LP-WUR detecting the LP-WUS.
Aspect 2: The method of Aspect 1, wherein the one or more characteristics associated with the UE include one or more of a UE type, a traffic pattern, a paging probability, an LP-WUS monitoring scheme, or an LP-WUS configuration associated with the UE.
Aspect 3: The method of any of Aspects 1-2, wherein the hopping pattern includes an LP-WUS hopping time interval and an LP-WUS hopping offset.
Aspect 4: The method of any of Aspects 1-3, further comprising: receiving, from the network node, information configuring an LP-WUS group set that includes one or more WUS groups, wherein the one or more WUS groups are associated with one or more WUS resources; and determining, among the one or more WUS groups included in the LP-WUS group set, an index associated with a WUS group, wherein the WUS group associated with the index is monitored for the LP-WUS.
Aspect 5: The method of any of Aspects 1-4, wherein the hopping pattern is an intra-resource hopping pattern associated with multiple WUS groups in one WUS resource.
Aspect 6: The method of any of Aspects 1-5, wherein the hopping pattern is an inter-resource hopping pattern across multiple WUS resources.
Aspect 7: The method of Aspect 6, wherein the inter-resource hopping pattern defines a fixed number of WUS groups per WUS resource and alternates among associations between WUS group identifiers and WUS resource identifiers.
Aspect 8: The method of Aspect 6, wherein the inter-resource hopping pattern defines fixed WUS group identifier groupings that are all alternated together between different WUS resource identifiers.
Aspect 9: The method of any of Aspects 1-8, wherein the hopping pattern includes an inter-resource hopping pattern that is used between two DRX cycles and an intra-resource hopping pattern that is used within one DRX cycle based at least in part on the LP-WUR monitoring for the LP-WUS according to a DRX configuration.
Aspect 10: The method of any of Aspects 1-9, wherein the WUS group that is monitored for the LP-WUS is associated with a first paging probability.
Aspect 11: The method of Aspect 10, further comprising: monitoring a WUS group associated with a second paging probability for the LP-WUS based at least in part on one or more conditions being satisfied, wherein the second paging probability is different from the first paging probability.
Aspect 12: The method of any of Aspects 1-11, wherein the hopping pattern for monitoring the LP-WUS is enabled or disabled by one or more bits included in a SIB.
Aspect 13: The method of any of Aspects 1-12, wherein the hopping pattern for monitoring the LP-WUS is enabled or disabled by an indication included in the LP-WUS.
Aspect 14: An apparatus for wireless communication at a device, comprising a processor; memory coupled with the processor; and instructions stored in the memory and executable by the processor to cause the apparatus to perform the method of one or more of Aspects 1-13.
Aspect 15: A device for wireless communication, comprising a memory and one or more processors coupled to the memory, the one or more processors configured to perform the method of one or more of Aspects 1-13.
Aspect 16: An apparatus for wireless communication, comprising at least one means for performing the method of one or more of Aspects 1-13.
Aspect 17: A non-transitory computer-readable medium storing code for wireless communication, the code comprising instructions executable by a processor to perform the method of one or more of Aspects 1-13.
Aspect 18: A non-transitory computer-readable medium storing a set of instructions for wireless communication, the set of instructions comprising one or more instructions that, when executed by one or more processors of a device, cause the device to perform the method of one or more of Aspects 1-13.

The foregoing disclosure provides illustration and description but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware and/or a combination of hardware and software. “Software” shall be construed broadly to mean instructions, instruction sets, code, code segments, program code, programs, subprograms, software modules, applications, software applications, software packages, routines, subroutines, objects, executables, threads of execution, procedures, and/or functions, among other examples, whether referred to as software, firmware, middleware, microcode, hardware description language, or otherwise. As used herein, a “processor” is implemented in hardware and/or a combination of hardware and software. It will be apparent that systems and/or methods described herein may be implemented in different forms of hardware and/or a combination of hardware and software. The actual specialized control hardware or software code used to implement these systems and/or methods is not limiting of the aspects. Thus, the operation and behavior of the systems and/or methods are described herein without reference to specific software code, since those skilled in the art will understand that software and hardware can be designed to implement the systems and/or methods based, at least in part, on the description herein.

As used herein, “satisfying a threshold” may, depending on the context, refer to a value being greater than the threshold, greater than or equal to the threshold, less than the threshold, less than or equal to the threshold, equal to the threshold, not equal to the threshold, or the like.

Even though particular combinations of features are recited in the claims and/or disclosed in the specification, these combinations are not intended to limit the disclosure of various aspects. Many of these features may be combined in ways not specifically recited in the claims and/or disclosed in the specification. The disclosure of various aspects includes each dependent claim in combination with every other claim in the claim set. As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (e.g., a+a, a+a+a, a+a+b, a+a+c, a+b+b, a+c+c, b+b, b+b+b, b+b+c, c+c, and c+c+c, or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or similar language is used. Also, as used herein, the terms “has,” “have,” “having,” or the like are intended to be open-ended terms that do not limit an element that they modify (e.g., an element “having” A may also have B). Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

1. A user equipment (UE) for wireless communication, comprising:
a memory; and
one or more processors, coupled to the memory, configured to:
receive, from a network node, information configuring a hopping pattern for monitoring a low-power wakeup signal (LP-WUS) based at least in part on one or more characteristics associated with the UE;
monitor, using a low power wakeup receiver (LP-WUR), a wakeup signal (WUS) for the LP-WUS based at least in part on the hopping pattern; and
wake a main radio from a deep sleep state based at least in part on the LP-WUR detecting the LP-WUS.

2. The UE of claim 1, wherein the one or more characteristics associated with the UE include one or more of a UE type, a traffic pattern, a paging probability, an LP-WUS monitoring scheme, or an LP-WUS configuration associated with the UE.

3. The UE of claim 1, wherein the hopping pattern includes an LP-WUS hopping time interval and an LP-WUS hopping offset.

4. The UE of claim 1, wherein the one or more processors are further configured to:
receive, from the network node, information configuring an LP-WUS group set that includes one or more WUS groups, wherein the one or more WUS groups are associated with one or more WUS resources; and
determine, among the one or more WUS groups included in the LP-WUS group set, an index associated with a WUS group, wherein the WUS group associated with the index is monitored for the LP-WUS.

5. The UE of claim 1, wherein the hopping pattern is an intra-resource hopping pattern associated with multiple WUS groups in one WUS resource.

6. The UE of claim 1, wherein the hopping pattern is an inter-resource hopping pattern across multiple WUS resources.

7. The UE of claim 6, wherein the inter-resource hopping pattern defines a fixed number of WUS groups per WUS resource and alternates among associations between WUS group identifiers and WUS resource identifiers.

8. The UE of claim 6, wherein the inter-resource hopping pattern defines fixed WUS group identifier groupings that are all alternated together between different WUS resource identifiers.

9. The UE of claim 1, wherein the hopping pattern includes an inter-resource hopping pattern that is used between two discontinuous reception (DRX) cycles and an intra-resource hopping pattern that is used within one DRX cycle based at least in part on the LP-WUR monitoring for the LP-WUS according to a DRX configuration.

10. The UE of claim 1, wherein the WUS group that is monitored for the LP-WUS is associated with a first paging probability.

11. The UE of claim 10, wherein the one or more processors are further configured to:
monitor a WUS group associated with a second paging probability for the LP-WUS based at least in part on one or more conditions being satisfied, wherein the second paging probability is different from the first paging probability.

12. The UE of claim 1, wherein the hopping pattern for monitoring the LP-WUS is enabled or disabled by one or more bits included in a system information block.

13. The UE of claim 1, wherein the hopping pattern for monitoring the LP-WUS is enabled or disabled by an indication included in the LP-WUS.

14. A method of wireless communication performed by a user equipment (UE), comprising:
receiving, from a network node, information configuring a hopping pattern for monitoring a low-power wakeup signal (LP-WUS) based at least in part on one or more characteristics associated with the UE;
monitoring, using a low-power wakeup receiver (LP-WUR), a wakeup signal (WUS) for the LP-WUS based at least in part on the hopping pattern; and
waking a main radio from a deep sleep state based at least in part on the LP-WUR detecting the LP-WUS.

15. The method of claim 14, wherein the one or more characteristics associated with the UE include one or more of a UE type, a traffic pattern, a paging probability, an LP-WUS monitoring scheme, or an LP-WUS configuration associated with the UE.

16. (canceled)

17. The method of claim 14, further comprising:
receiving, from the network node, information configuring an LP-WUS group set that includes one or more WUS groups, wherein the one or more WUS groups are associated with one or more WUS resources; and
determining, among the one or more WUS groups included in the LP-WUS group set, an index associated with a WUS group, wherein the WUS group associated with the index is monitored for the LP-WUS.

18-21. (canceled)

22. The method of claim 14, wherein the hopping pattern includes an inter-resource hopping pattern that is used between two discontinuous reception (DRX) cycles and an intra-resource hopping pattern that is used within one DRX cycle based at least in part on the LP-WUR monitoring for the LP-WUS according to a DRX configuration.

23. The method of claim 14, wherein the WUS group that is monitored for the LP-WUS is associated with a first paging probability.

24. The method of claim 23, further comprising:
monitoring a WUS group associated with a second paging probability for the LP-WUS based at least in part on one or more conditions being satisfied, wherein the second paging probability is different from the first paging probability.

25-26. (canceled)

27. A non-transitory computer-readable medium storing a set of instructions for wireless communication, the set of instructions comprising:
one or more instructions that, when executed by one or more processors of a user equipment (UE), cause the UE to:
receive, from a network node, information configuring a hopping pattern for monitoring a low-power wakeup signal (LP-WUS) based at least in part on one or more characteristics associated with the UE;
monitor, using an LP-WUR, a wakeup signal (WUS) for the LP-WUS based at least in part on the hopping pattern; and
wake a main radio from a deep sleep state based at least in part on the LP-WUR detecting the LP-WUS.

28. (canceled)
